(19) United States
(12) Patent Application Publication
(10) Pub. No.: US 2011/0089277 A1
(43) Pub. Date: Apr. 21, 2011

(54) Compact Manual Shredder

(76) Inventors: Hsuan-Yu Chao, Taipei City (TW); Mei-Mei Tsai, Taipei City (TW)

(21) Appl. No.: 12/750,606

(22) Filed: Mar. 30, 2010

(30) Foreign Application Priority Data
Oct. 20, 2009 (CN) 200920219614.3

(51) Int. Cl. B02C 18/14; B02C 18/24

(52) U.S. Cl. 241/169.1; 241/227

(57) ABSTRACT

A compact manual shredder includes : a housing, being a column type tube body, constituted by upper and lower shells covered with each other, the upper shell being disposed with a paper entrance, the lower shell being disposed with a paper outlet and a pair of interlaced and side-by-side fragmentation cutters being configured inside the housing; and a transmission device, having a rotating unit disposed on one end of said housing and a gear train, two ends thereof being respectively coupled to the cutter pair and the rotating unit. Whereby, the rotating unit of the transmission device drives the gear train to rotate, and further drives the cutters to cut paper into fragments.

### BACKGROUND OF THE INVENTION

1. Field of the Invention

The present invention relates to a compact manual shredder, and more particularly to a small and portable fragmentation shredder.

2. Description of Related Art

As we know, all general conventional shredders are a heavy console box type body, which is not moved and carried conveniently. However, the current commercial activities are frequent and numerous, making arrangement with or consulting with each other out of office are very often; taking a conventional shredder with one out of office is impossible. Numerous confidential waste paper must be destroyed with a shredder after a commercial contact or activity. But, because the shredder is not portable, there have no choice but tear those waste papers apart with hands by oneself; not only such kind of the action is labor and time wasting, but also the paper fragments cannot be handled such that confidential cannot be truly kept.

Currently, although there is a portable shredder with a volume smaller than a console one, commercial power or several batteries must be used as a power in it and a motor and driving element must be operated in cooperation with it, causing the shredder to have a certain weight and volume, a transformer must be carried on one's person while being used out of office such that it is very inconvenient. Besides, paper can only be cut into strips and cannot be fragmented such that a confidential keeping effect is bad.

### SUMMARY OF THE INVENTION

To improve the deficits mentioned above, the present invention is proposed.

The present invention proposes a compact manual shredder, mainly including: a housing, being a column type tube body constituted by covering upper and lower shells on each other, the upper shell being disposed a paper entrance, the lower shell being disposed with a paper outlet, and one pair of interlaced side-by-side fragmentation cutters are disposed inside the housing; a transmission device, having a rotating unit installed on one end of the housing and two ends of a gear train being respectively coupled to the cutter pair and the rotating unit; wherein, the gear train is driven by the rotating unit of the transmission device to further drive the cutters to move, thereby achieving a paper fragmentation action.

### BRIEF DESCRIPTION OF THE DRAWINGS

The present invention can be more fully understood by reference to the following description and accompanying drawings, in which:

FIG. 1 is an exploded view of a manual shredder according to the present invention;

FIG. 2 is a cross sectional view of a manual shredder according to the present invention;

FIG. 3 is a perspective view of a manual shredder provided with a sleeve according to the present invention'

FIG. 4 is a perspective view of a manual shredder put into practice;

FIG. 5 is a perspective view, showing a manual shredder according to the present invention on which paper fragmentation is being carried out;

FIG. 6 is a cross sectional view of a manual shredder with two gear trains perspectively installed at the two sides thereof according to the present invention;

FIG. 7 is a cross sectional view of a manual shredder with a cutter with a lengthened rotating shaft according to the present invention;

FIG. 8 is a bottom view of a manual shredder in which a cover plate is coupled pivotally to a paper outlet according to the present invention;

FIG. 9 is a schematic view of a manual shredder covered with a bag according to the present invention; and

FIG. 10 is a schematic of a paper fragments collection by the bag shown in FIG. 10.

### DETAILED DESCRIPTION OF THE PREFERRED EMBODIMENTS

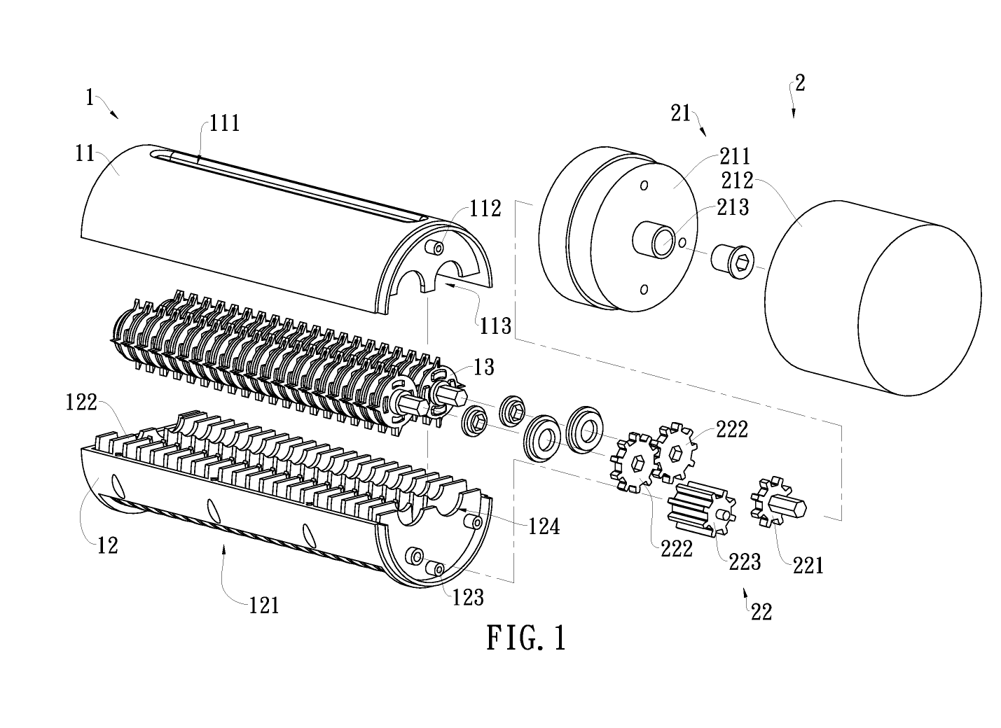

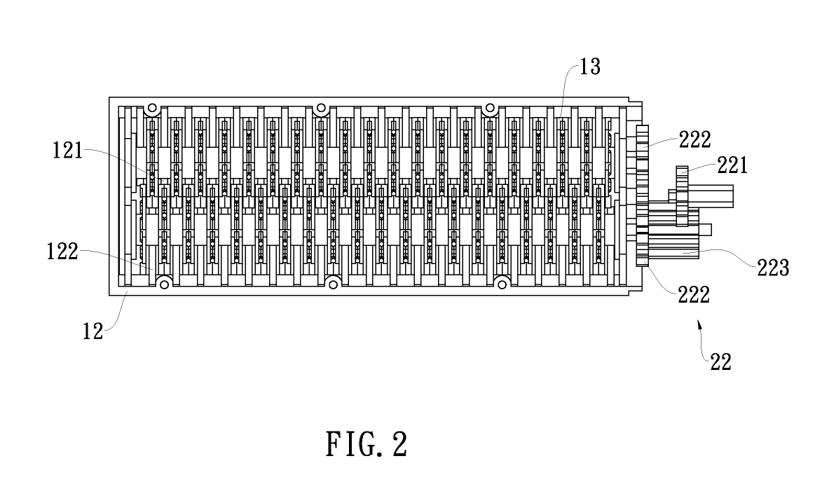

First, please refer to FIGS. 1 and 2. A compact manual shredder according to the present invention mainly includes a housing 1 and a transmission device 2.

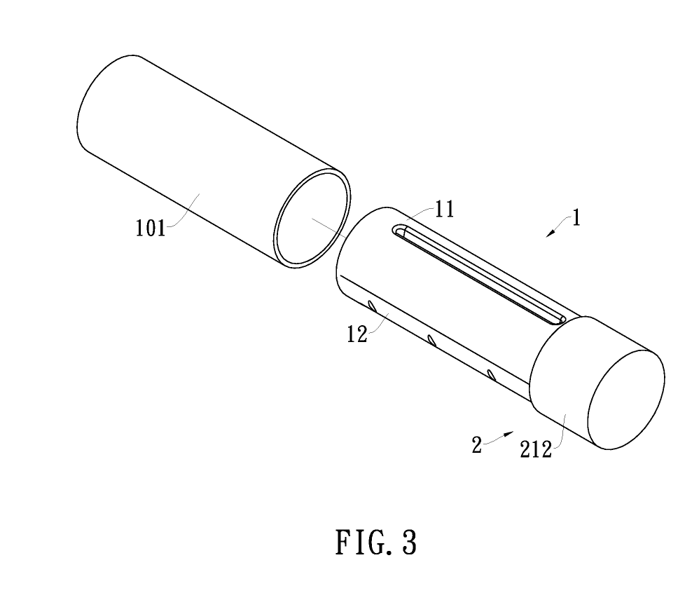

The housing 1 is a column type tube body as FIGS. 3-5 show; it may be a circular, elliptical, triangular, quadrangular, polygonal, or other geometric column type tube body. The housing 1 is constituted by a upper shell 11 and a lower shell 12 covered on each other, where one pair of interlaced side-by-side fragmentation cutter 13 are installed inside the housing 1. The upper shell 11 is disposed with a paper entrance 111 on the center thereof, the lower shell 12 is disposed with a paper outlet 121 corresponding to the paper entrance 111, and a plurality of equidistant comb-typed sheets are respectively disposed on the upper and lower shells 11 and 12 (the comb-typed sheets of the upper shell 11 are not shown), thereby preventing the paper fragments from being rotated with the cutter 13, and a bad cutting of the shredder or the paper jamming from being yielded. Furthermore, one end of the upper shell 11 and one end of the lower shell 12 are respectively disposed with at least one hole 112 and hole 123 adapted to couple to the transmission device 2 and several slots 111 and 124 adapted to allow the cutters 13 to be passed through to couple to the transmission device 2.

The transmission device 2 has a rotating unit 21 and a gear train 22, where the rotating unit 21 includes a fixing element 211 and a rotating element 212. The fixing element 211 is fixed on one end of the housing 1 which has an accepting space used for receiving the gear train 22. Furthermore, an axle hole 213 is disposed on the fixing element 211, thereby allowing a rotating shaft of the gear train 22 to be passed through to extend outward to couple to the rotating element 212. Furthermore, the rotating element 212 is coupled pivotally to another end of the fixing element 211 and can be rotated relatively to the fixing element 211.

The gear train 22 includes a driving wheel 221, at least two driven wheels 222 and a transmission wheel 223, where a rotating shaft of the driving wheel 221 is lengthened outward to fix on the rotating unit 21, the two driven wheels are respectively fixed on one end of the pair of the interlaced and side-by-side cutters and engaged with each other, and the transmission wheel 223 is installed beside the driving wheel 221 and the driven wheel 222 and used for engaging with the driving wheel 221 and the driven wheel 222 so as to drive the driven wheel 222 to rotate.

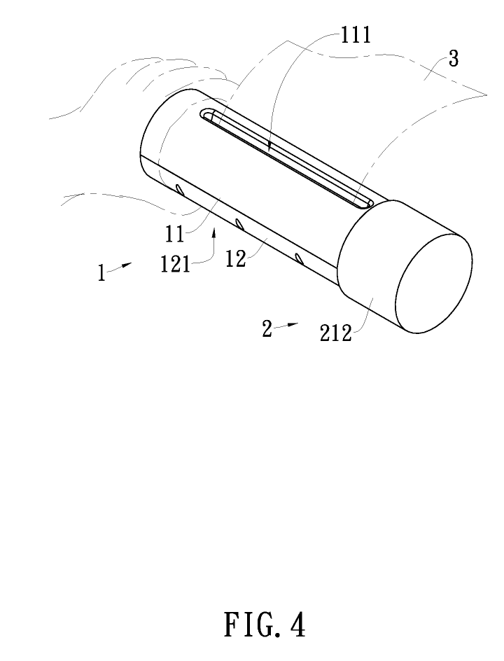

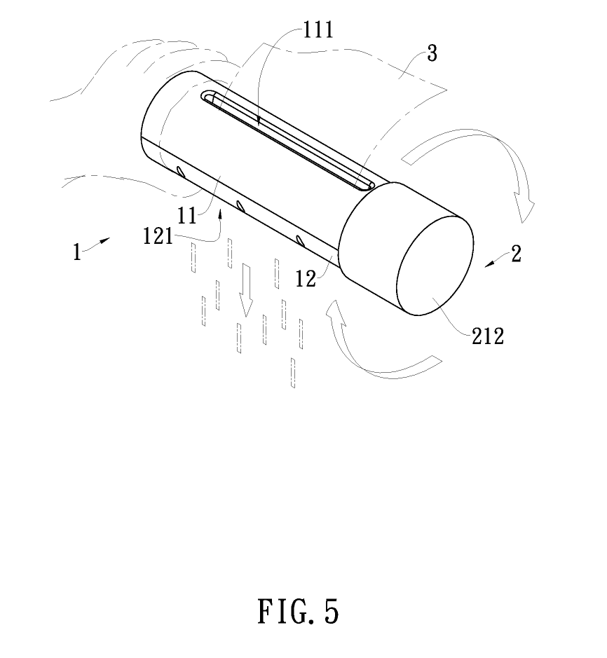

Please refer to FIG. 3. While the present invention is put into practice, a sleeve can be put around the housing 1, thereby increasing functions such as eye-appealing integral modeling and shredder protection. Furthermore, a carrying strap (not shown in the figure) may be configured on the sleeve 101 so as to be convenient for a user's carrying.

Whereupon, referring to FIGS. 4 and 5, while the present invention is put into practice, a user may take the sleeve 101 down, places a piece of paper or a few pieces of paper into the paper entrance 111 of the upper shell 11, and then use one hand to hold one side of the housing 1 tightly and another hand to rotate the rotating element 212 of the transmission device 2 at another side of the housing 1 relatively to the fixing element 211 so as to drive the driving wheel 221 fixed on the rotating unit 21 to rotate to drive the transmission wheel 223 to rotate, thereby driving the driven wheel 222 to rotate, then driving the fragmentation cutters 13 to carry out cutting. Therefore, a paper fragmentation action can be completed.

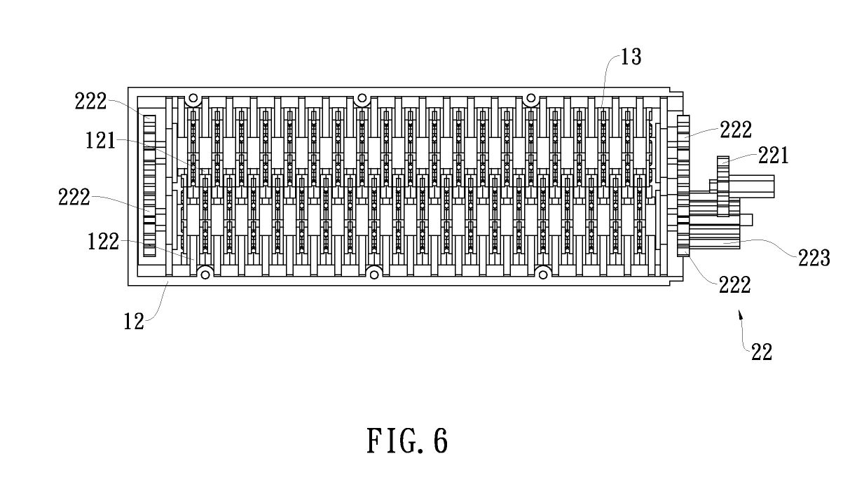

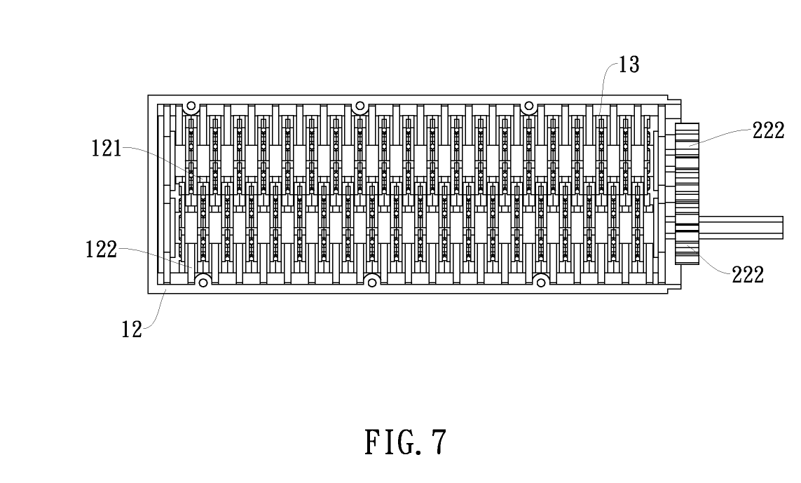

Furthermore, the structure design and assembly of the present invention can have more diverse changes according to the modeling difference of the housing 1 depending on customization. For example, as FIG. 6 shows, the gear train 22 may also be respectively configured on the two sides of the cutter pair when the present invention is put into practice so as to increase the stability when the cutters 13 are being rotated and allow it to be subjected to a uniform force for a convenient rotation. Otherwise, as FIG. 7 shows, only the two driven wheels 222 in the gear train 22 are configured beside the cutters 13, and the shaft of one of the two cutters 13 is lengthened to couple to the rotating unit 31, thereby driving the cutters 13 to carry out the cutting directly through the rotating unit 21. Accordingly, the paper entrance 111 and the paper outlet 121 must be respectively configured on positions of the upper and lower shells 11 and 12 deviating from the positions thereof shown in FIG. 1.

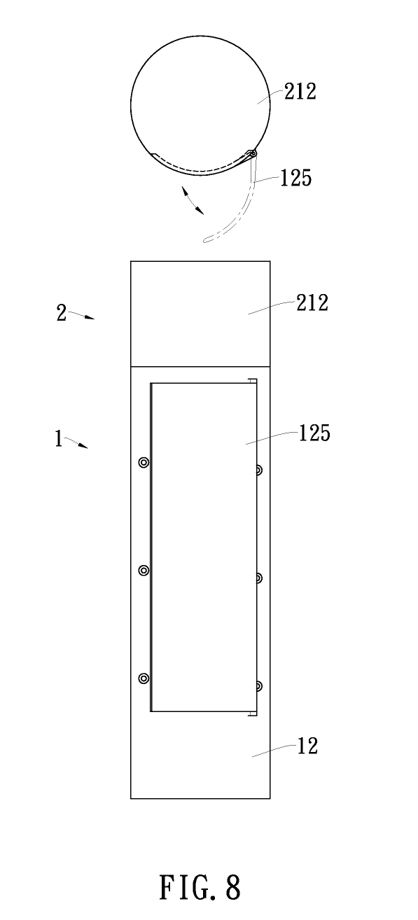

Furthermore, referring to FIG. 8, a cover 125 or a sliding cover sheet (not shown in the figure) may also be coupled pivotally to the paper entrance 121 of the housing 1, thereby allowing an eye-appealing integral modeling of the shredder, preventing a hand from being inserted in the paper entrance 121 carelessly so as to avoid hurting the hand and preventing a stiff object from dropping in the paper entrance 121 so as to protect the shredder from being damaged. Besides, another merit of the planning of the cover 125 is that the cover 125 can be used as the final limit of the hand grasping, and a user's hand can also exert a force on the cover 125 in an instant as a matter of course along a force exerting direction to cover the paper entrance 121 if the user operate the rotating element 212 with the overlarge force and the hand slips out carelessly such that the user's hand can be prevented from being hurt by the paper entrance 121 and the comb-typed sheets 122, thereby providing a good protection.

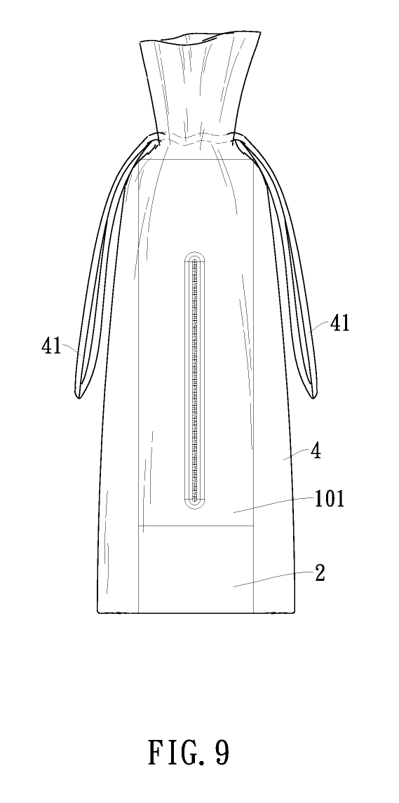

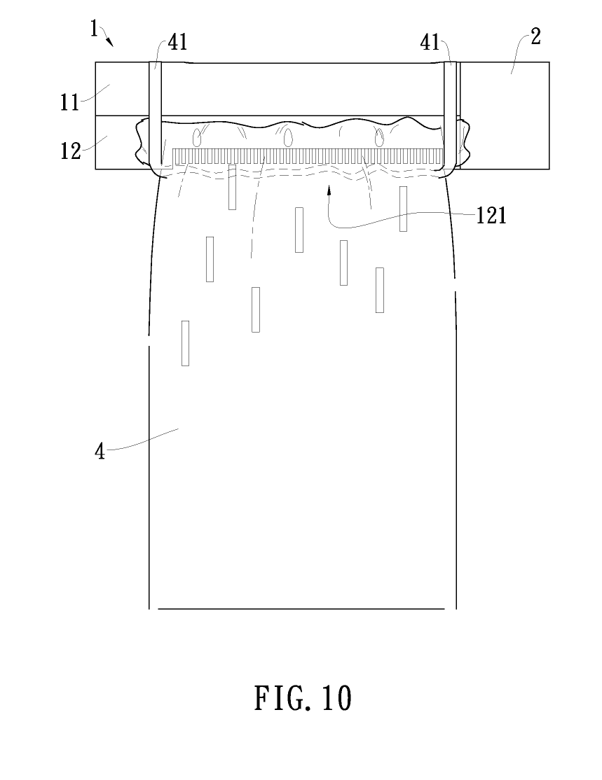

Please refer to FIG. 9. A bag 4 may be put around the shredder of the present invention, and one end thereof is configured with a pull string 41, thereby tying an opening of the bag up; the bag 4 is used for receiving the shredder in order to carry it conveniently and have the eye-appealing integral collocation modeling of the shredder. Finally, please refer to FIG. 10. When the shredder is in use, the pull string 41 of the bag 4 may be put around the housing 1 to allow the bag 4 to be hung below the paper outlet 121 of the housing so as to collect paper fragments expelled from the paper outlet 121, thereby preventing the paper fragments from flying around.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A compact manual shredder, comprising:
a housing, being a column type tube body, constituted by upper and lower shells covered with each other, the upper shell being disposed with a paper entrance, said lower shell being disposed with a paper outlet and a pair of interlaced and side-by-side fragmentation cutters being configured inside said housing;
a transmission device, having a rotating unit disposed on one end of said housing and a gear train, two ends thereof being respectively coupled to said cutter pair and said rotating unit, said rotating unit comprising a fixing element and a rotating element, said fixing element being fixed on one end of said housing and having an accepting space adapted to receive said gear train, an axle hole being disposed on said fixing element and allowing a rotating shaft of said gear train to be passed through and extended out to couple to said rotating element, and said rotating element being coupled pivotally to another end of said fixing element and capable of being rotated relatively to said fixing element;
whereby, said rotating unit of said transmission device drives said gear train to rotate, and further drives said cutters to cut paper into fragments.

2. The compact manual shredder according to claim 1, wherein said housing is one of a group constituted by circular, elliptical, triangular, quadrilateral, polygonal and other geometric column type tube bodies.

3. The compact manual shredder according to claim 2, wherein said gear train is installed on each end of said cutter pair.

4. The compact manual shredder according to claim 2, wherein said gear train is installed on one end of said cutter pair.

5. The compact manual shredder according to claim 4, wherein said gear train comprises a driving wheel fixed on said rotating unit, two driven wheels respectively fixed on one end of said cutter pair and a transmission wheel respectively engaged with said driving wheel and said driven wheel.

6. The compact manual shredder according to claim 4, wherein said gear train comprises two driven wheels respectively fixed on one end of said cutter pair, and one rotating shaft of said cutter pair is lengthened to couple to said rotating unit.

7. The compact manual shredder according to claim 1, wherein said paper entrance and said paper outlet are respectively disposed on a center of said upper shell and a center of said lower shell.

8. The compact manual shredder according to claim 7, wherein a cover is coupled pivotally to a planning position of said paper outlet of said lower shell.

9. The compact manual shredder according to claim 7, wherein a sleeve is put around said housing.

10. The compact manual shredder according to claim 7, further comprising a bag receiving said shredder, and capable of being placed below said shredder to collect paper fragments after being taken down from said shredder.
